(19) United States
(12) Patent Application Publication
(10) Pub. No.: US 2012/0122054 A1
(43) Pub. Date: May 17, 2012

(54) Container for Dispensing a Pasty Filling Compound for Use with a Hand-held Device and Hand-held Device

(75) Inventor: Frank Emde, Memmingen (DE)

(73) Assignee: Kaltenbach & Voigt GmbH, Biberach (DE)

(21) Appl. No.: 13/381,849

(22) PCT Filed: Jul. 9, 2010
(86) PCT No.: PCT/EP10/59879

§ 371 Date: Jan. 23, 2012

(30) Foreign Application Priority Data
Jul. 9, 2009 (DE) 10 2009 032 494.1

(51) Int. Cl. A61C 5/04; A61C 5/06

(52) U.S. Cl. 433/86; 433/89; 433/118

(57) ABSTRACT

A container for use with a hand-held device, in particular for dental purposes, for dispensing a pasty filling compound, the viscosity of which can be reduced by supplying vibration energy, wherein the container is designed to receive the pasty filling compound and comprises a discharge opening at the front end for dispensing the filling compound. The discharge opening is formed by a cannula which is made of steel, for example. The viscosity of the filling compound can be positively influenced by the cannula. In this way, in particular a significant increase in the liquefaction degree of the filling compound can be achieved.

The invention relates to a container for use with a hand-held device, in particular for dental purposes, for dispensing a pasty filling compound whose viscosity can be reduced by supplying vibration energy, wherein the container is formed to receive the pasty filling compound and at its front end has a discharge opening for dispensing the filling compound. Moreover, the invention relates to a corresponding hand-held device with such a container.

A hand-held device of the generic type and a container of the generic type are described in German Patent Application DE 10 2009 013 000 belonging to the applicant.

In the case of oscillation- or vibration-assisted discharge of a corresponding filling compound (also referred to as filling material), usually vibrations from a vibration generator are introduced into such a container, with the filling compound being located in the container. The vibration generator can be, for example, a sound- or ultrasound-generator that is located in the hand-held device. As regards the prior art, reference is made in particular to the above-mentioned application DE 10 2009 013 000. As a result of the to-and-fro swinging movement, the filling compound that is located in the container is subjected to shear forces that result in the viscosity of the filling compound being lowered or decreasing and the filling compound thus being able to flow on easily, for example, at a tooth cavity. This is advantageous for the connection between the filling compound and the corresponding cavity. For a high-quality filling it is therefore basically desirable for a high degree of liquefaction of the pasty filling compound to be attainable.

Generally, after the filling compound has been discharged, for example into a tooth cavity, there is mechanical action on the filling compound, in particular in order to compact it and/or to bring it into a specific form. It is therefore advantageous if the container and the handpiece respectively are configured in such a way that they can also be used for corresponding mechanical processing of the filling compound introduced into a cavity.

The underlying object of the invention is to specify a corresponding container with which the production of a high-grade filling is facilitated. Moreover, a corresponding hand-held device is to be specified.

This object is achieved in accordance with the invention with the subject-matter mentioned in the independent claims. Special embodiments of the invention are specified in the dependent claims.

In accordance with the invention a container is provided for use with a hand-held device, in particular for dental purposes, for dispensing a pasty filling compound whose viscosity can be reduced by supplying vibration energy; the container is in this connection formed to receive the pasty filling compound and at its front end has a discharge opening for dispensing the filling compound. The discharge opening is formed by means of a cannula.

By means of the cannula it is possible to attain a positive influence on the viscosity of the filling compound when working with the hand-held device. In particular, a significant increase in the degree of liquefaction can be achieved in this way.

Advantageously, the cannula consists of a material that has a different specific weight from the rest of the container. The cannula preferably consists of steel, aluminum or ceramic material. These materials have turned out to be particularly favorable with regard to the increase in the degree of liquefaction, in particular for the case where the rest of the container or at least a part of the rest of the container directly adjacent to the cannula consists of plastics material.

Advantageously, the cannula is flexible or curved. As a result, a situation can be attained where the filling compound can be better advanced to certain spatial regions, in the dental field for example to mesial boxes. In the case of a flexible cannula—for example an aluminum cannula—advantageously an individual or indication-related pre-bending of the cannula can be effected during a treatment. Advantageously, the cannula is then bendable by hand.

Advantageously, the cannula is connected to the rest of the container by way of an adhesive connection, a press fit or a screw connection, or the cannula is connected to the rest of the container by casting around it during the production of the container.

In accordance with a second aspect of the invention a container is provided for use with a hand-held device, in particular for dental purposes, for dispensing a pasty filling compound whose viscosity can be reduced by supplying vibration energy; the container is in this connection formed to receive the pasty filling compound and at its front end has a discharge opening for dispensing the filling compound. The discharge opening is then arranged in a region of the container that has an outer surface at least substantially describing a hemispherical form.

The hemispherical region can be utilized to process mechanically, in particular to compact, the filling compound after discharge of the filling compound into a cavity. The region can thus be used in the sense of a tamping tool.

Advantageously, the region is then part of a thickened end portion of the container.

Advantageously, the discharge opening is then arranged asymmetrically, in particular laterally, in relation to the polar axis fixed by the hemispherical form. As a result, accessibility to narrow cavities can be facilitated.

In accordance with a third aspect of the invention a container is provided for use with a hand-held device, in particular for dental purposes, for dispensing a pasty filling compound whose viscosity can be reduced by supplying vibration energy; the container is in this connection formed to receive the pasty filling compound and at its front end has a discharge opening for dispensing the filling compound. Furthermore, the container has a cap for closing the discharge opening.

Advantageously, the cap is then formed as a preferably wedge-shaped shaping tip. As a result of the vibration effect, particularly easy and form-closing modeling of the filling material introduced into the cavity can be attained with the shaping tip.

In accordance with a further aspect of the invention a hand-held device, in particular for dental purposes, is provided that has a in accordance with the invention.

The invention is explained in greater detail in the following with the aid of exemplary embodiments and with reference to the drawings, in which:

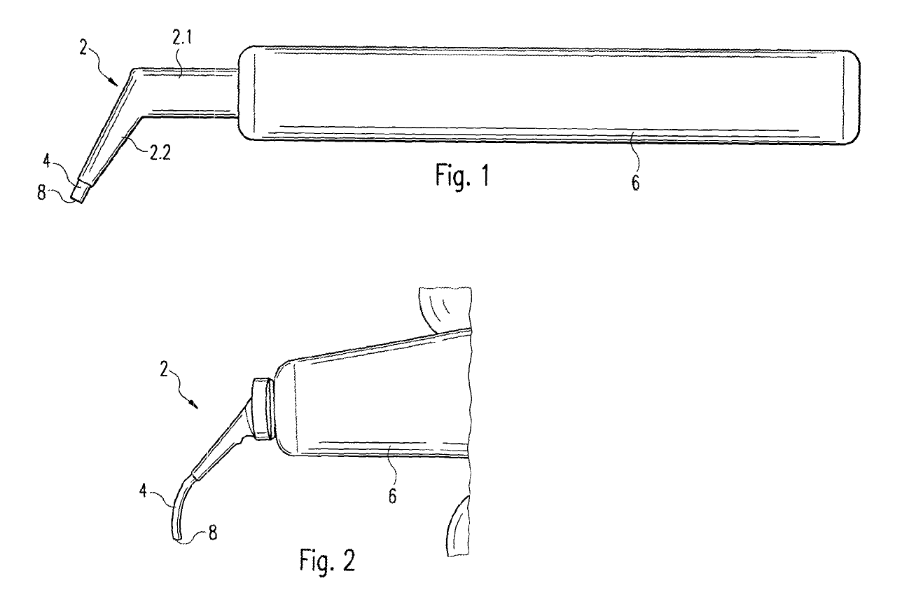

FIG. 1 shows a sketch relating to a first exemplary embodiment of a container and hand-held device in accordance with the invention;

FIG. 2 shows a variant of the first exemplary embodiment with a curved cannula;

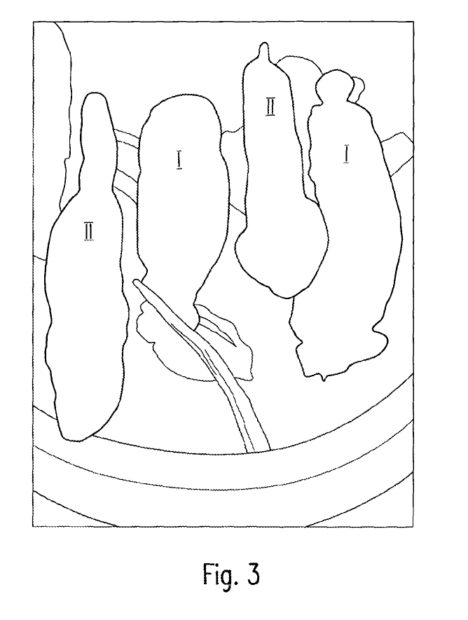

FIG. 3 shows four sample bodies, shown by way of example, that have been produced with and without the aid of a container in accordance with the invention;

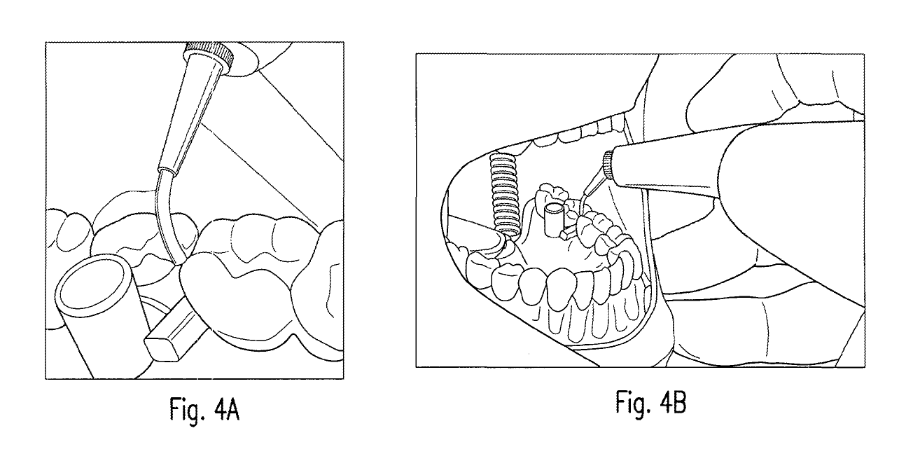

FIGS. 4A and 4B show sketches relating to the accessibility of a container or hand-held device in accordance with the invention to a dental cavity;

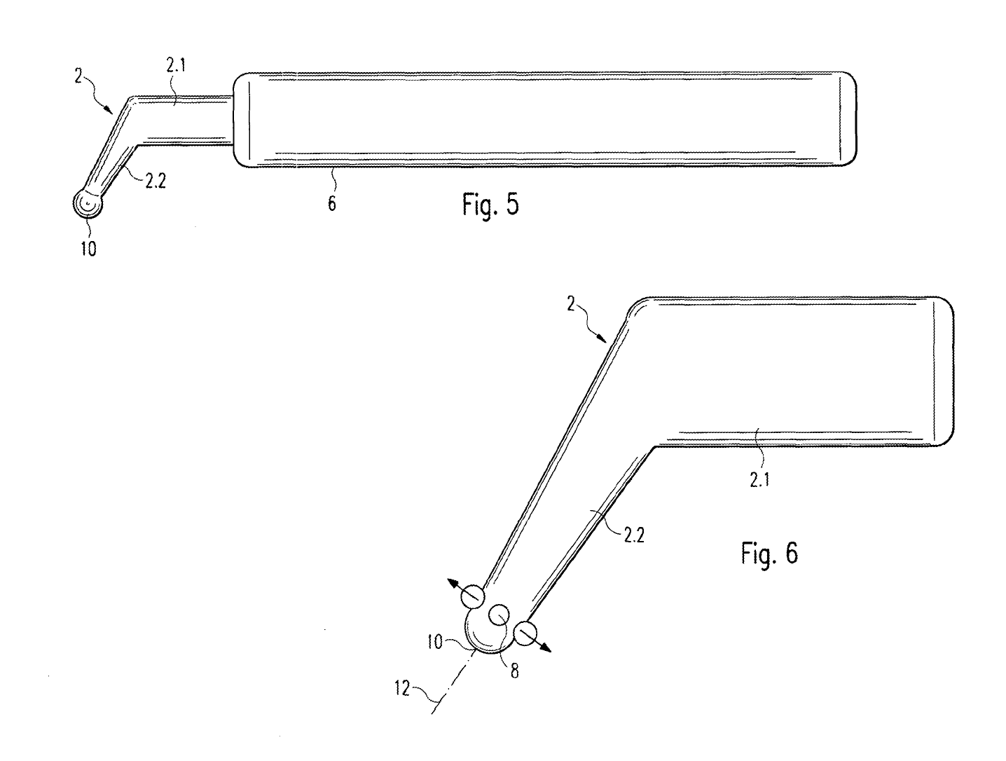

FIG. 5 shows a sketch relating to a second exemplary embodiment of a container and hand-held device in accordance with the invention;

FIG. 6 shows a sketch relating to a further exemplary embodiment; and

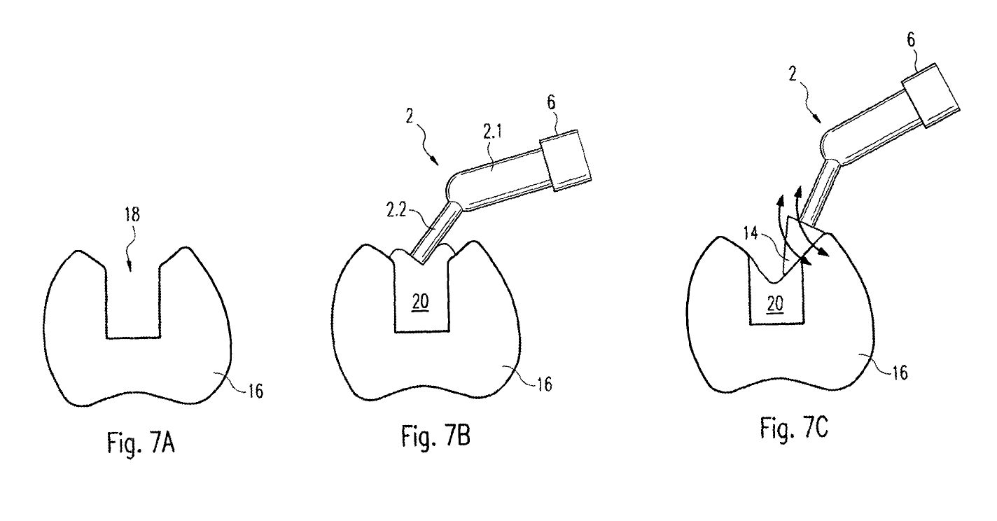

FIGS. 7A to 7C show sketches relating to the use of a container or hand-held device in accordance with the invention with the use of a cap that is formed as a shaping tip.

A sketch relating to a first exemplary embodiment of a container 2 in accordance with the invention and of a hand-held device 6 in accordance with the invention respectively is shown in FIG. 1. The container 2 and the hand-held device 6 having the container 2 are used to dispense a pasty filling compound whose viscosity can be reduced by supplying vibration energy. In this connection, the container 2 and the hand-held device 6 respectively can be provided in particular for dispensing the filling compound into a dental cavity. The container 2 is formed to receive the pasty filling compound and at its front end has a discharge opening 8 for dispensing the filling compound.

The hand-held device 6 can have a vibration generator (not shown separately in the figures), for example in the form of a sound- or ultrasound-generator for the generation of the vibrations, which are then transferred to the container 2.

The container 2 can be in particular a container as described in the above-mentioned German Patent Application DE 10 2009 013 000. In the specification mentioned, the container 2 is also referred to as a cartridge and can, for example, have a storage or receiving container, provided to receive the filling compound, and also a nozzle which can be configured in particular so that it tapers towards the outlet opening. Express reference is made to the content of the specification DE 10 2009 013 000, and the content is to be incorporated in the present description. In FIG. 1 the reference numeral 2.1 in this sense denotes a storage or receiving container of the container 2, and the reference numeral 2.2 denotes a nozzle of the container 2.

As a result of a special configuration of the container 2 in the region of the outlet opening 8—in comparison with the prior art mentioned—a positive influence on the viscosity of the filling compound can be attained when working with the hand-held device 6. The discharge opening 8 of the container 1 is formed for this purpose by means of a cannula 4. The cannula 4 in this connection can in particular be a separate component. The cannula 4 can then be let into or inserted into the rest of the container 2, for example into the nozzle 2.1. The cannula 4 can be formed by means of a small tube with an inside diameter that is constant over the whole of its length.

The cannula 4 can consist, for example, of a material that has a specific weight different from the rest of the container 2. The cannula 4 then preferably consists of steel, aluminum or ceramic material. The nozzle 2.1 can then—as known per se from the prior art—consist of plastics material.

As a result of an exact adjustment of the length ratio of the cannula 4 with the nozzle 2.1 to the material of the filling compound that is used, a significant increase in the degree of liquefaction can be achieved. In FIG. 3, four sample bodies are shown, by way of example, that have been produced with and without the aid of a container 2 in accordance with the invention. The sample bodies denoted by I are formed in accordance with the prior art mentioned with the use of a plastics nozzle; the sample bodies denoted by II are formed with the use of a container in accordance with the invention with a steel cannula. The sample bodies denoted by I in accordance with the prior art have comparatively great scale formations and duller surfaces. This shows that in the case of the production of the sample bodies in accordance with the invention, denoted by II, the degree of liquefaction of the filling compound was significantly better or higher.

As indicated in FIG. 2, the cannula 4 can be curved or flexible. As a result, better accessibility to different cavities can be attained. In the dental field of application, for example, in this way mesial boxes can be reached in a better way, as indicated in FIGS. 4A and 4B. For example, for this the cannula 4 can consist of aluminum so that it can be bent by hand, in particular also during a treatment, into a shape that is specially adapted to the respective treatment.

A curved cannula 4 cannot be produced by injection-moulding technology in conjunction with a conical nozzle 2.2 or can only be produced with considerable outlay.

As a result of the use of metal as a material for the cannula 4, moreover, instances of abrasion or melt-down of the plastics material upon contact with the treated tooth can be prevented. Other materials, for example ceramic material, can, however, also be used for the cannula 4.

An adhesion, a press fit or a screw connection can be provided in order to connect the cannula 4 to the rest of the container 2, that is, to the nozzle 2.2, for example. It is also possible to provide for the cannula 4 to be connected to the rest of the container 2 or the nozzle 2.2 by casting around it during the production of the container 2.

A sketch relating to a second exemplary embodiment of a container 2 and hand-held device 6 in accordance with the invention is shown in FIG. 5. Unless presented otherwise in the following, the statements made with reference to the first exemplary embodiment mentioned above apply in an analogous manner.

In the case of the second exemplary embodiment the discharge opening is arranged in a region 10 of the container 2 that has an outer surface at least substantially describing a hemispherical form. For example, the region 10 can be part of a thickened end portion of the container 2 or the nozzle 2.2 preferably describing a spherical form. As a result of such a thickened portion it is possible to attain an increase in the periphery in relation to the part of the nozzle 2.2 directly adjacent thereto. After the filling compound has been discharged into a cavity, the region 10 can be used as a tamping tool with which the filling compound can be compacted. The handling is thereby facilitated overall.

An example is shown in FIG. 6 in which the discharge opening 8 is arranged asymmetrically, in particular laterally, in relation to the polar axis 12 fixed by the hemispherical form. As indicated in the sketch of FIG. 6, in this connection a plurality of discharge openings can be arranged therein. In particular, it can then be provided that no opening is provided through which the polar axis 12 passes. The discharge opening 8 or the discharge openings can be arranged, for example, in the region of the equator of the hemispherical form.

As a result of this configuration in particular the accessibility to narrow cavities can be facilitated. Moreover, the region 10 of the container 2 can be used as a tamping tool or modeling tip.

In the case of the two examples shown with the aid of FIGS. 5 and 6, the region 10 that has an outer surface at least substantially describing a hemispherical form can be formed by a separate attachment that can be set onto the rest of the container 2 or onto the nozzle 2.2. Alternatively, it can be formed so as to be integral with the rest of the container 2.

In the case of all the exemplary embodiments shown it can be provided that the cannula 4 or the front end region of the nozzle 2.2 is manufactured from a material that has a specific weight that differs from the specific weight of the material of the rest of the container 2, that is, even in the case of integral production.

Sketches relating to a third exemplary embodiment of a container 2 and handpiece 6 respectively in accordance with the invention are shown in FIGS. 7A, 7B, 7C. Unless otherwise specified, the statements made above apply in turn in an analogous manner. In the case of this embodiment, the container 2 has a cap 14 to close the discharge opening 8 or, if applicable, the discharge openings.

A tooth 16 with a cavity 18 is sketched in FIG. 7A. The state in which the cavity 18 has already been filled with filling compound 20—beyond the preparation edges—with the aid of the container 2 is shown in FIG. 7B. In FIG. 7C it is shown how it is possible to influence the shape of the filling compound 20 introduced into the cavity 18 with the cap 14 that is formed as a modeling or shaping tip. In particular, the cap 14 can have a wedge form for this. The work with the shaping tip can be particularly facilitated by the vibrations that are transferred to the container 2 and thus to the cap 14 set thereon.

1. A container for use with a hand-held device for dispensing a pasty filling compound whose viscosity can be reduced by supplying vibration energy, wherein the container is formed to receive the pasty filling compound and at a front end has a discharge opening for dispensing the filling compound, wherein the discharge opening is formed by a cannula.

2. A container according to claim 1, in which the cannula comprises a material that has a different specific weight than the rest of the container.

3. A container according to claim 1, in which the cannula comprises steel, aluminum, or ceramic material.

4. A container according to claim 1, in which the cannula is flexible or curved.

5. A container according to claim 1, in which the cannula is connected to the rest of the container by way of an adhesive connection or a press fit or a screw connection, or the cannula is connected to the rest of the container by casting around it during the production of the container.

6. A container for use with a hand-held device for dispensing a pasty filling compound whose viscosity can be reduced by supplying vibration energy, wherein the container is formed to receive the pasty filling compound and at a front end has a discharge opening for dispensing the filling compound, wherein the discharge opening is arranged in a region of the container that has an outer surface at least substantially describing a hemispherical form.

7. A container according to claim 6, in which the region is part of a thickened end portion of the container.

8. A container according to claim 6, in which the discharge opening is arranged asymmetrically in relation to the polar axis fixed by the hemispherical form.

9. A container for use with a hand-held device for dispensing a pasty filling compound whose viscosity can be reduced by supplying vibration energy, wherein the container is formed to receive the pasty filling compound and at a front end has a discharge opening for dispensing the filling compound, the container comprising a cap for closing the discharge opening.

10. A container according to claim 9, in which the cap is formed as a shaping tip.

11. A hand-held device, comprising a container according to claim 1.

12. A container according to claim 8, in which the discharge opening is arranged laterally in relation to the polar axis fixed by the hemispherical form.

13. A container according to claim 10, in which the cap is formed as a wedge-shaped shaping tip.

14. A hand-held device comprising a container according claim 6.

15. A hand-held device comprising a container according claim 9.
